(19) United States
(12) Patent Application Publication
(10) Pub. No.: US 2026/0213032 A1
(43) Pub. Date: Jul. 23, 2026

(54) APPARATUS FOR THE PRODUCTION OF RADIOISOTOPES

(71) Applicant: NANO IMRAD TECHNOLOGY, INC., Irving, TX (US)

(72) Inventors: Paul PEVSNER, Irving, TX (US); Richard R. JOHNSON, Vancouver (CA); Devon Cyril SAUNDERS, Borden, CA (US)

(21) Appl. No.: 19/568,296

(22) Filed: Mar. 16, 2026

Related U.S. Application Data
(63) Continuation of application No. PCT/US2024/047277, filed on Sep. 18, 2024.
(60) Provisional application No. 63/538,920, filed on Sep. 18, 2023.

(51) Int. Cl. G21G 1/10; G21G 1/00

(52) U.S. Cl. CPC G21G 1/10; G21G 1/001; G21G 2001/0089; G21G 2001/0094

(57) ABSTRACT

An isolation window assembly for solid-target-type cyclotron target apparatus, the isolation window assembly comprising: (a) an isolation window that comprises (i) a heat conducting layer and (ii) optionally, a tensile strength layer in contact with, or secured to the heat conducting layer; and (b) a collar sized and configured to: (i) sealingly connect with the isolation window around the perimeter of the isolation window; and (ii) be sealingly assembled as part of the target apparatus. A target support for a solid-target-type cyclotron target apparatus, wherein the target support comprises: (a) a front surface having a depression that is sized and configured to load a solid target material; and (b) a back surface that partially defines a support liquid cooling passageway in the target apparatus. A kit for forming an assembled solid-target-type cyclotron target apparatus, the kit comprising said isolation window assembly and said target support.

### CROSS-REFERENCE TO RELATED APPLICATIONS

This application is a continuation application of International Application PCT/US2024/047277 filed on Sep. 18, 2024, which claims the benefit of U.S. Prov. Application 63/538,920 filed on Sep. 18, 2023, which are incorporated herein by reference in their entireties.

### BACKGROUND OF INVENTION

Using a cyclotron to produce radionuclides using mostly liquid or gas targets is a well-established technology. Such radionuclides are produced on an almost daily basis and represent the bulk of targetry solutions used with cyclotrons. Referring to FIG. 10, is a schematic drawing of a previously known apparatus for irradiating a liquid target 4, an accelerator beam line 1 (e.g., a proton beam) travels to the isolation window 2 and passes from a vacuum region 6 through the isolation window 2 losing energy and heating the window 2. The proton beam 1 then enters the target region 3 containing H₂O-18 as the liquid target 4 losing energy until it stops. The H₂O-18 is heated by the proton beam 1 and the pressure in target region 3 increases. A cooling water jacket 5 surrounds the target region 3 to remove heat and thus minimize the temperature and pressure increases of the H₂O-18. The isolation window 2 does experience high temperatures because of its thickness and can suffer material damage.

Referring to FIG. 11, which is a schematic drawing of a previously known apparatus for irradiating a gaseous target, an accelerator beam line 1 (e.g., a proton beam) travels to the isolation window 2 configuration, in this case a double window, and passes from a vacuum region 6 through the isolation window 2 losing energy and heating the window 2. A windows of double window configuration are cooled by circulating helium gas in cooling circuit 7 (partially depicted) having an inlet 8 and an outlet 9. Both the gaseous target 4 in the target region 3 and the helium gas are operated at high pressure to increase the density of the target gas and helium cooling respectively. As an example, iodine-123 is created using a gas target (see, e.g., EP0096730).

Solid targets present a number of difficulties when compared to gas and liquid targets. First, expensive enriched target materials are often required to produce radionuclides of a high purity. Second, the heat conductivity is much lower, which can lead to overheating problems. Care must be taken to optimize the cooling system and beam parameters to avoid melting of the target. Usually, an inclined target configuration is used with an angle of a few degrees between the incident beam and the target material surface. This ensures the entering beam power heat is dissipated over a larger target area. Third, a layer of target material is typically a few hundred micrometers thick and is formed, for example, by electrodeposition or power pressing followed by sintering, powder rolling, laser plating, or forming a high melting point alloy. Fourth, solid state targets require more manual handling, which may result in a higher radiation hazard for personnel, especially if the target must be retrieved shortly after irradiation. Last, solid target materials generally require more complex chemical separation and recycling processes.

Apostolidis et al. disclosed producing actinium-225 by proton irradiation of radium-226 in the form solid RaCl₂ target material, wherein the target material is between silver foil sheets that are pressed together, encapsulated with silver capsules, that are welded gas-tight. Apostolidis et al., Cyclotron Production of Ac-225 for Targeted Alpha Therapy, Applied Radiation and Isotopes 62 (2005) pp. 383-387.

A need still exists for simpler, less costly apparatus for irradiating target materials, including solid target material.

### SUMMARY OF INVENTION

In one embodiment, the present invention is directed to an isolation window assembly for solid-target-type cyclotron target apparatus, the isolation window assembly sized and configured to be sealingly assembled as part of the target apparatus that also comprises a target support and a support liquid cooling passageway for flowing a liquid to contact at least a portion of the target support, wherein the target support is loaded with a solid target material that comprises an element that, upon bombardment via a cyclotron, yields at least a radioisotope, wherein the isolation window assembly comprises:
(a) an isolation window that is sized, configured, and comprises materials suitable for the transmission of particles from a cyclotron with enough kinetic energy to transform the element to the radioisotope but not so much as to cause the target support to fail, and suitable to withstand the pressure difference between a vacuum pressure within the target apparatus and atmospheric pressure outside the target apparatus, wherein the isolation window comprises a front surface and back surface, and wherein the isolation window comprises:
   (i) a heat conducting layer that comprises a heat conducting material with a thermal conductivity, in-plane, of at least 1,000 W/m-K; and
   (ii) optionally, a tensile strength layer in contact with, or secured to the heat conducting layer, wherein the tensile strength layer comprises a high tensile strength material with a tensile strength, ultimate, of at least 800 MPa; and
(b) a collar sized and configured to:
   (i) sealingly connect with the isolation window around the perimeter of the isolation window, including portions of the front and back surfaces of isolation window proximate to the perimeter of the isolation window; and
   (ii) be sealingly assembled as part of the target apparatus, including forming a seal with, and partially defining an isolation window liquid cooling passageway in the target apparatus thereby allowing liquid to flow through the isolation window liquid cooling passageway and contact at least a portion of the collar and transport heat from the collar.

In one embodiment, the present invention is directed to a target support for a solid-target-type cyclotron target apparatus, wherein the target support is sized and configured to be sealingly assembled as part of the target apparatus that also comprises a support liquid cooling passageway for flowing a liquid to contact at least a portion of the target support, and wherein the target support comprises:
(a) a front surface having a depression that is sized and configured to load a solid target material that comprises an element that, upon bombardment via a cyclotron, yields at least a radioisotope; and
(b) a back surface sized and configured to seal with, and thereby partially define the support liquid cooling passageway in the target apparatus thereby allowing for liquid to flow through the support liquid cooling passageway and contact at least a portion of the back surface and transport heat from the support.

In one embodiment, the present invention is directed to a kit for forming an assembled solid-target-type cyclotron target apparatus, the kit comprising: the above-described isolation window assembly and the above-described target support, and the remaining components necessary for forming the assembled target apparatus.

In one embodiment, the present invention is directed to a method producing a radioisotope from a solid target material, the method comprising:
loading the depression of the above-described target support with the solid target material that comprises an element that, upon bombardment via a cyclotron, yields at least a radioisotope;
assembling a solid-target-type cyclotron target apparatus comprising the loaded target support, the above-described isolation window assembly, and the remaining components necessary for forming the assembled target apparatus;
and
directing particles from a cyclotron through the isolation window into the interior of the assembled target apparatus to strike the target material and transform the element to the radioisotope.

### BRIEF DESCRIPTION OF THE DRAWINGS

FIG. 1 is an schematic drawing of a target station 20 installed in an accelerator beam line 1, wherein the target station 20 comprises an assembled solid-target-type cyclotron target apparatus 30 attached to mounting plate 21, which is mounted to a support stand 22.

FIG. 2 is a schematic drawing depicting a beam line 1 and an assembled target apparatus 30 having cooling ports 33; and an exploded view of an embodiment of an isolation window 41 and clamp 31 outside of the assembled target apparatus 14, wherein the isolation window 41 comprises a tensile strength layer 45 (e.g., TZM vacuum isolation sheet), an optional adhesive layer 46, heat conducting layer 44 (e.g., pyrolytic graphite), and an optional surface sealant 47.

FIG. 3 is a schematic drawing (with dimensions in millimeters) of an embodiment of a target apparatus 30 having coolant ports 33 and pressure equalization ports 34 in which an isolation window 41 (not depicted) is secured by clamp 31 with (A) being exploded and (B) being assembled and rotated 90° clockwise from (A).

FIG. 4 is a schematic drawing (with dimensions in millimeters) showing the interfaces within an embodiment of target apparatus 30 comprising clamp 31 for securing isolation window 41 (not depicted), bolt holes 37, coolant channel 36, and gasket 35.

FIG. 5 is an image of a computer aided drawing that depicts an embodiment of target apparatus 30 showing a placement/configuration of channels and mounting screws that avoid interference.

FIG. 6 is a drawing of an embodiment of component segments with associated information, including dimensions in millimeters, wherein: Flange Size/OD is KF40 (2.16 inches/54.86 mm OD); Type is half nipple, clamp style; Flange Material is 304L SS; Nominal Tube OD is 1.50 inches/38.1 mm; Bore is 1.335 inches/33.91 mm; Overall Length is 1.58 inches/40.13 mm.

FIG. 7 contains schematic drawings of three views (above, side, and side cross-section) of an embodiment of a target support 50 for a solid target material with dimensions in millimeters.

FIG. 8 contains schematic drawings of two views (above, and side cross-section) of an embodiment of a target support 50 for a solid target material with dimensions in millimeters.

FIG. 9 is a schematic drawing of an embodiment of an isolation window 40.

FIG. 10 is a schematic drawing of a previously known apparatus for irradiating a liquid target.

FIG. 11 is a schematic drawing of a previously known apparatus for irradiating a gaseous target.

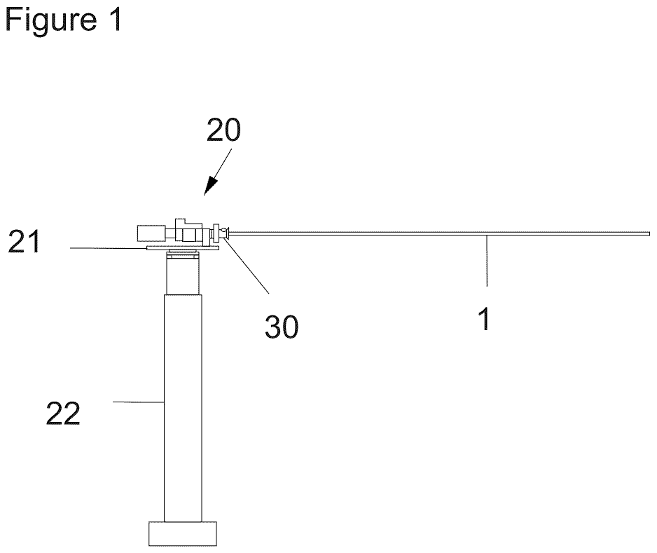

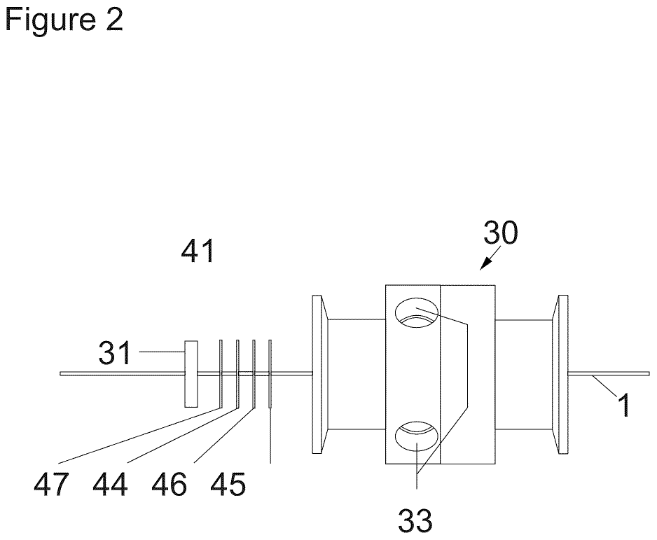

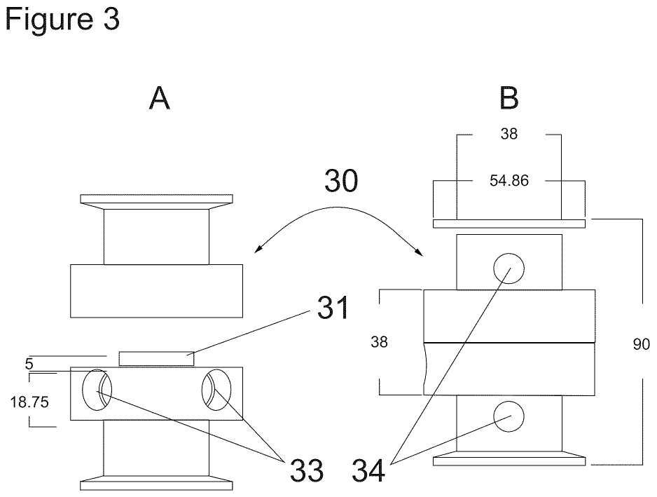

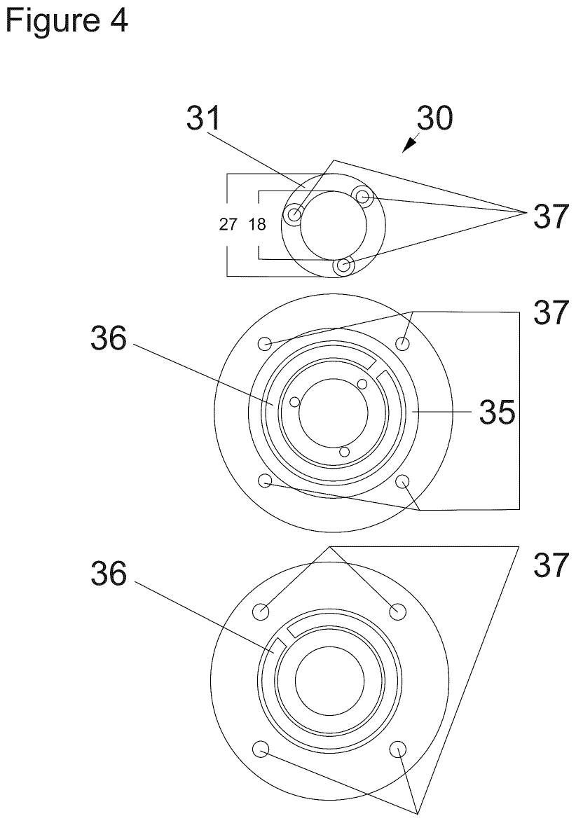

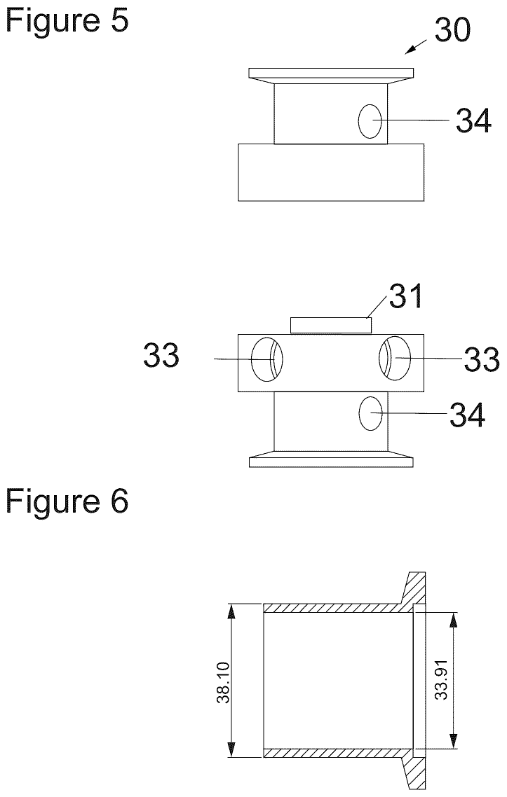

### DETAILED DESCRIPTION OF INVENTION

Medical therapeutic radioisotopes can be produced with a (p,n) reaction using a cyclotron with a proton beam directed at a target material in an appropriate target support.

One embodiment of the present invention is directed to a target support or “coin” configured from, for example, 24 carat gold coin to be a repository for the target material or “substrate” (e.g., radium-226), which is placed within a depression or cavity formed (e.g., machined) on the target support. The target support (sized and configured for a particular or standard solid-target cyclotron target apparatus) with the applied target material may be placed or loaded in an assembled solid-target cyclotron target apparatus. As used with respect to the present invention, the term “target apparatus” applies to solid-target-type target apparatuses for use in connection with cyclotrons.

Another embodiment of the present invention is directed to an isolation window assembly for a target apparatus. In one embodiment, the isolation window assembly comprises a molybdenum disk with an applied pyrolytic graphite sheet, which may be placed in the beamline between the cyclotron and the target to prevent any contamination of the cyclotron by radioactive products on the target.

### Isolation Window Assembly

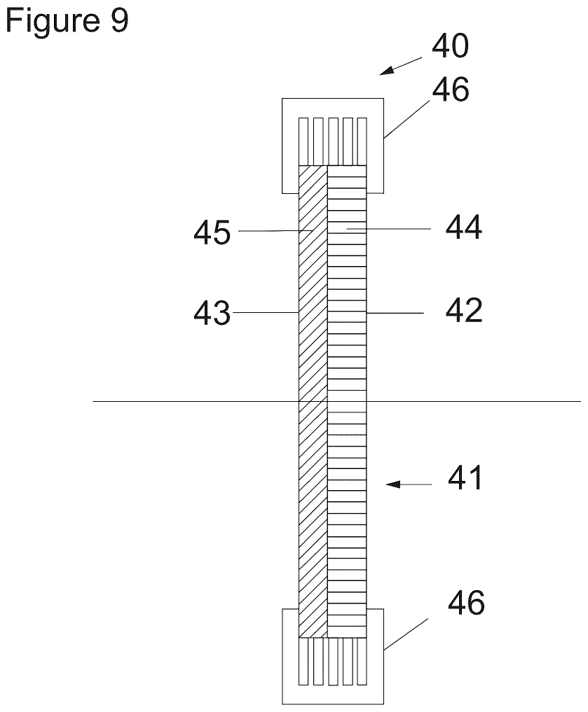

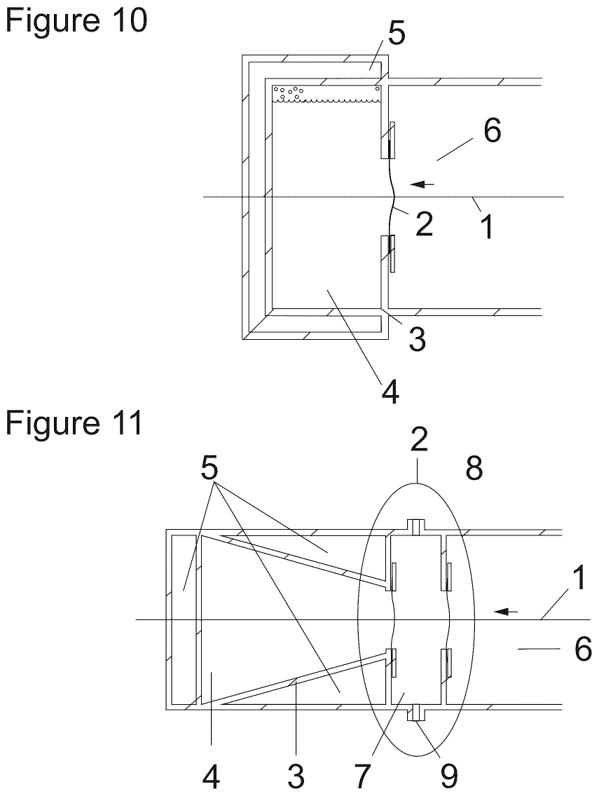

Referring to FIG. 9, one embodiment of the present invention is directed to an isolation window assembly 40 for solid-target-type cyclotron target apparatus 30. The isolation window assembly 40 is sized and configured to be sealingly assembled as part of the target apparatus 30 that also comprises a target support 50 and a support liquid cooling passageway (not depicted) for flowing a liquid (not depicted) to contact at least a portion of the target support 50. In use, the target support 50 is loaded with a solid target material (not depicted) that comprises an element that, upon bombardment via a cyclotron, yields a desired radioisotope.

### Isolation Window

The isolation window assembly 40 comprises an isolation window 41 that is sized, configured, and comprises materials suitable for the transmission of particles from a cyclotron with enough kinetic energy to transform the element to the radioisotope but not so much as to cause the target support 50 to fail. Additionally, the isolation window assembly 40 is sized and configured to withstand the pressure difference between a vacuum pressure within the target apparatus 30 and beam-line operating pressure outside the target apparatus. The isolation window 41 comprises a front surface 42 and back surface 43.

### Heat Conducting Layer

The isolation window also comprises a heat conducting layer 44 that comprises a heat conducting material with a thermal conductivity, in-plane, of at least 1,000 W/m-K.

In an embodiment, the heat conducting material is selected from the group consisting of pyrolytic graphite. In another embodiment, the heat conducting material is pyrolytic graphite. In yet another embodiment, the heat conducting material is pyrolytic graphite and the heat conducting layer is cylindrical and has an axial thickness in a range of about 10 μm to about 50 μm.

The following Table A sets forth various physical properties of different pyrolytic graphite materials.

TABLE A
Typical Properties of HPMS Pyrolytic Graphite

| | | HGS- | HGS- | HGS- | HGS- | HGS- | HGS- | HGS- |
|---|---|---|---|---|---|---|---|---|
| Property | Unit | 012 | 017 | 025 | 040 | 050 | 070 | 100 |
| Color | — | Silver gray | | | | | | |
| Thickness | mm | 0.012 | 0.017 | 0.025 | 0.040 | 0.050 | 0.070 | 0.100 |
| Density | g/cc | 2.1 | 2.1 | 1.92 | 1.8 | 1.7 | 1.20 | 0.85 |
| Typical | W/m-K | 1800 | 1800 | 1750 | 1400 | 1350 | 1300 | 1050 |
| Thermal | | | | | | | | |
| Conductivity, | | | | | | | | |
| In-Plane | | | | | | | | |
| Typical | W/m-K | 10 | 11 | 18 | 20 | 20 | 20 | 26 |
| Thermal | | | | | | | | |
| Conductivity, | | | | | | | | |
| Through- | | | | | | | | |
| Plane | | | | | | | | |
| Thermal | cm²/s | 10-12 | 10-11 | 9-10 | 9-10 | 8-10 | 8-10 | 8-10 |
| Diffusivity | | | | | | | | |
| Tensile | Mpa | 40 | 40 | 25 | 20 | 20 | 20 | 20 |
| Strength | | | | | | | | |
| Electrical | S/cm | 20000 | 20000 | 20000 | 10000 | 10000 | 10000 | 10000 |
| Conductivity | | | | | | | | |

| | | |
|---|---|---|
| Operating | ° C. | −40 to 400 |
| Temperature | | |
| Heat | ° C. | 400 |
| Resistance | | |
| Specific Heat | J/kg-° K | 850 |
| @50° C. | | |
| RoHS | Y/N | Yes |
| complaint | | |

### Tensile Strength Layer

The isolation window of the isolation window assembly, may optionally, further comprise a tensile strength layer 45 in contact with, or secured to the heat conducting layer 44, wherein the tensile strength layer 45 comprises a high tensile strength material with a tensile strength, ultimate, of at least 800 MPa.

In an embodiment, the high tensile strength material is selected from the group consisting of molybdenum, molybdenum TZM alloy (Mo-0.5Ti-0.1Zr; Mo alloy 364), cobalt-based alloy UNS R30004 (which possesses a very high mechanical strength; available from Hamilton Precision Metals under the tradename Havar®), and combinations thereof. In another embodiment, the high tensile strength material is molybdenum TZM alloy (Mo-0.5Ti-0.1Zr; Mo alloy 364). In yet another embodiment, the high tensile strength material is molybdenum TZM alloy and the tensile strength layer is cylindrical and has an axial thickness in a range of about 20 μm to about 50 μm.

The following Tables B and C set the composition and physical properties, respectively, of molybdenum TZM alloy.

TABLE B
Molybdenum TZM (Mo—0.5Ti—0.1Zr; Mo Alloy 364)

| Component | Wt. % |
|---|---|
| C | 0.01-0.04 |
| Fe | Max 0.01 |
| H | Max 0.0005 |
| Mo | 99.4 |
| N | Max 0.002 |
| Ni | Max 0.005 |
| O | Max 0.03 |
| Si | Max 0.005 |
| Ti | 0.4-0.55 |
| Zr | 0.06-0.12 |

TABLE C

| Physical Properties | Metric | | English | |
|---|---|---|---|---|
| Density | 10.16 | g/cc | 0.367 | lb/in³ |
| Mechanical Properties | | | | |
| Tensile Strength, Ultimate | 965 | MPa | 140000 | psi |
| Tensile Strength, Yield | 860 | MPa | 125000 | psi |
| Modulus of Elasticity | 325 | GPa | 47100 | ksi |
| 10% | 10% | | 10% | |
| Electrical Properties | | | | |
| Electrical Resistivity | 5.7e−006 | ohm-cm | 5.7e−006 | ohm-cm |
| Magnetic Susceptibility | 9.3e−007 | | 9.3e−007 | |
| Critical Magnetic Field Strength, Oersted | 93-99 | | 93-99 | |
| Critical Superconducting Temperature | 0.91-0.92 | K | 0.91-0.92 | K |
| Thermal Properties | | | | |
| Heat of Fusion | 293 | J/g | 126 | BTU/lb |
| CTE, linear 20° C. | 4.9 | μm/m-° C. | 2.72 | μin/in-° F. |
| CTE, linear 250° C. | 5.9 | μm/m-° C. | 3.28 | μin/in-° F. |
| CTE, linear 500° C. | 6 | μm/m-° C. | 3.33 | μin/in-° F. |
| CTE, linear 1000° C. | 6.1 | μm/m-° C. | 3.39 | μin/in-° F. |
| Heat Capacity | 0.255 | J/g-° C. | 0.0609 | BTU/lb-° F. |
| Thermal Conductivity | 118 | W/m-K | 819 | BTU-in/hr-ft²-° F. |
| Melting Point | Max 2620° | C. | Max 4750° | F. |

The following Tables D, F, and F set forth the Composition, Mechanical, and Physical properties, respectively, of cobalt-based alloy UNS R30004 available from Hamilton Precision Metals under the tradename Havar®.

TABLE D
HAVAR ® NOMINAL COMPOSITION

| | |
|---|---|
| Cobalt | 42.0% |
| Chromium | 19.5% |
| Nickel | 12.7% |
| Tungsten | 2.7% |
| Molybdenum | 2.2% |
| Manganese | 1.6% |
| Carbon | 0.2% |
| Iron | Balance |

TABLE E
Mechanical Properties
HAVAR ® MECHANICAL PROPERTIES

| | | | COLD |
|---|---|---|---|
| | | | ROLLED |
| | | COLD | HEAT |
| | ANNEALED | ROLLED | TREATED |
| Ultimate Tensile | 140,000 PSI | 270,000 PSI | 330,000 PSI |
| Strength | | | |
| Yield Strength | 70,000 PSI | 250,000 PSI | 300,000 PSI |
| (0.2% Offset) | | | |
| Elongation in 2″ * | 40% | 1% | 1% |
| Hardness | RC 25 | RC50 | RC60 |
| Modulus of | 29.5 × | — | — |
| Elasticity (Tension) | 10⁶ PSI | | |

* The measured elongation will be less as thickness decreases to 0.002″ and less.

TABLE F
Physical Properties
HAVAR ® PHYSICAL PROPERTIES

| Density | 0.300 | lbs/cu · in. |
|---|---|---|
| Melting Point (Approx.) | 1480° | C. |
| Electrical Resistivity @ R.T. | 92 | Microhm · cm |
| Thermal Expansion Coefficient (0° to 50° C.) | 12.5 × 10⁻⁶/° C. | |
| Thermal Conductivity | 13.0 | W/m · K |

| | |
|---|---|
| Magnetic Attraction | None |

The tensile strength layer 45 acts as a strong barrier even at pressure differences between a vacuum and atmosphere or more. The particle beam 1, as it passes, through isolation window 41 creates heat. The greatest amount of heat generation occurs in the high tensile strength layer 45, especially if that layer's thickness is greater than the heat conducting layer 44 to accommodate the pressure difference encountered. But the high thermal conducting of the heat conducting layer 44 (e.g., the thermal conductivity of pyrolytic graphite is typically about 15 times greater than that of molybdenum and its alloys) allows for heat to transfer to and through the heat conducting layer 44 and subsequently to chilled water (not depicted) via the collar 46 (described below).

### Collar

Referring to FIG. 9, the isolation window assembly 40 further comprises a collar 46 that is sized and configured to sealingly connect with the isolation window 41 around the perimeter of the isolation window 41, including portions of the front surface 42 and back surface 43 of isolation window 41 proximate to the perimeter of the isolation window 41. Additionally, the collar 46 is sized and configured to be sealingly assembled as part of the target apparatus 30, including forming a seal with, and partially defining an isolation window liquid cooling passageway (not depicted) in the target apparatus 30 thereby allowing liquid to flow through the isolation window liquid cooling passageway and contact at least a portion of the collar 46 and transport heat from the collar. In an embodiment, the collar 46 is aluminum or an aluminum alloy due to its relative ease of machining and relatively low radioactivation.

### Target Support

Referring to FIGS. 8 and 9, one embodiment of the present invention is directed to a target support 50 for a solid-target-type cyclotron target apparatus 30. The target support 50 is sized and configured to be sealingly assembled as part of the target apparatus 30 that also comprises a support liquid cooling passageway (not depicted) for flowing a liquid (not depicted) to contact at least a portion of the target support 50. The target support 50 comprises:
a front surface 51 having a depression 52 that is sized and configured to load a solid target material (not depicted) that comprises an element that, upon bombardment via a cyclotron, yields at least a radioisotope; and
a back surface 53 sized and configured to seal with, and thereby partially define the support liquid cooling passageway (not depicted) in the target apparatus thereby allowing for liquid (not depicted) to flow through the support liquid cooling passageway (not depicted) and contact at least a portion of the back surface 53 and transport heat from the support 50.

In one embodiment, the depression 52 is sized and configured to optimize the amount of target material (not depicted) relative to the size and configuration of the target support 50 and the intended cyclotron particle bombardment (e.g., the incoming beam energy 1).

In one embodiment such as depicted in FIG. 8, the target support 50 comprises a target support material that is 24 carat gold because of its relatively high thermal conductivity (~350 W/m-K) in combination with being resistant to corrosion, oxidation, and other chemical reactions. The target support 50 is cylindrical having an axial thickness of about 2 mm, a diameter of about 24 mm, and the depression 52 is a coaxial cylindrical void having a depth, measured from the front surface 51 toward the back surface 53, of about 1.5 mm and a diameter of about 10 mm.

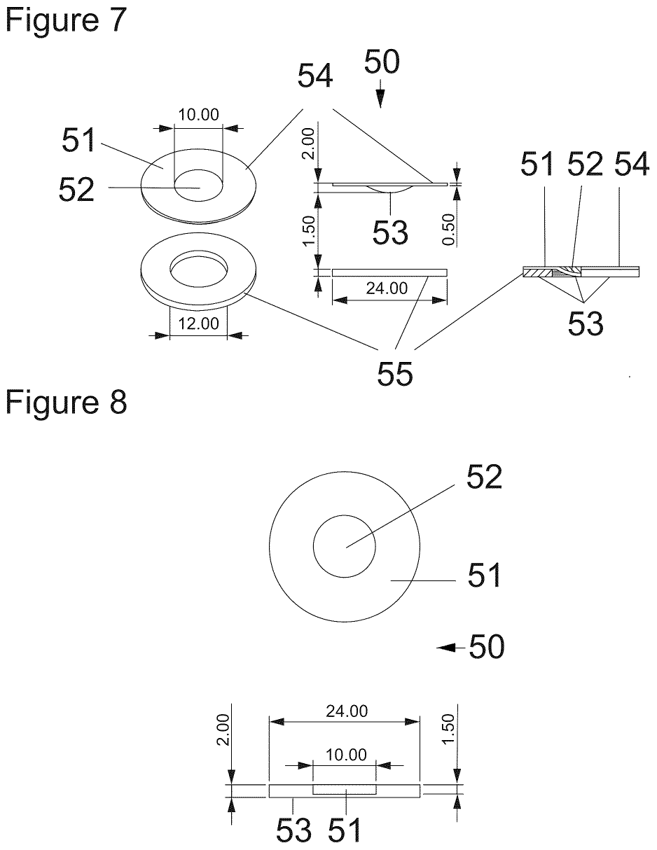

In one embodiment such as depicted in FIG. 7, the target support 50 comprises a target support material layer 54 that is 24 carat gold because of its relatively high thermal conductivity (~350 W/m-K) in combination with being resistant to corrosion, oxidation, and other chemical reactions. The target support material layer 54 is cylindrical having an axial thickness of about 0.5 mm, a diameter of about 24 mm, and the depression 52 is coaxial concavity having a depth, measured from the front surface 51 to the back surface 53, of about 1.5 mm and a diameter of about 10 mm. The total axial thickness of the target support material layer 54 from the front surface 51 to the back surface 53 is about 2 mm. The target support material layer 54 is sized and configured to interface with a target support ring 55 that is aluminum. The target support ring 55 is a hollow cylinder having an axial thickness of about 1.5 mm, an outer diameter of about 24, and a coaxial inner diameter of about 12 mm.

### Target Material

In one embodiment, the target material comprises an element that, upon bombardment via a cyclotron, yields at least a radioisotope corresponding to at least one of the following element/isotope pairs: ²²⁶Ra/²²⁵Ac.

### Target Apparatus Kit

One embodiment of the present invention is directed to a kit for forming an assembled solid-target-type cyclotron target apparatus. The kit comprises:
an isolation window assembly as described above;
a target support as described above; and
the remaining components necessary for forming the assembled target apparatus.

### Method of Producing a Radioisotope

One embodiment of the present invention is directed to a method of producing a radioisotope from a solid target material. The method comprises:
loading the depression of the target support as described above with the solid target material that comprises an element that, upon bombardment via a cyclotron, yields at least a radioisotope;
assembling a solid-target-type cyclotron target apparatus comprising the loaded target support, the isolation window assembly as described above, and the remaining components necessary for forming the assembled target apparatus;
and directing particles from a cyclotron through the isolation window into the interior of the assembled target apparatus to strike the target material and transform the element to the radioisotope.

In another embodiment, the method further comprising processing the bombarded target material to isolate the radioisotope.

### OTHER REMARKS

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit and scope of the invention. All such similar substitutes and modifications apparent to those skilled in the art are deemed to be within the spirit, scope and concept of the invention as defined by the appended claims.

To the extent necessary to provide descriptive support, the subject matter and/or text of the appended claims is incorporated herein by reference in their entirety. It will be understood by all readers of this written description that the exemplary embodiments described and claimed herein may be suitably practiced in the absence of any recited feature, element or step that is, or is not, specifically disclosed herein.

Throughout this disclosure, the term “a” or “an” entity refers to one or more of that entity. As such, the terms “a” (or “an”), “one or more,” and “at least one” can be used interchangeably herein.

Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

Unless defined otherwise, technical and scientific terms used herein have the same meaning as commonly understood by one of ordinary skill in the art to which this disclosure is related. Numeric ranges are inclusive of the numbers defining the range. The use of “any range in-between” means that, for example, if the values 1, 2, and 5 are stated, then the ranges 1 to 2, 1 to 5, and 2 to 5 are all specifically disclosed.

The headings provided herein are not limitations of the various aspects or aspects of the disclosure, which can be had by reference to the specification as a whole.

What is claimed is:

1. An isolation window assembly for solid-target-type cyclotron target apparatus, the isolation window assembly sized and configured to be sealingly assembled as part of the target apparatus that also comprises a target support and a support liquid cooling passageway for flowing a liquid to contact at least a portion of the target support, wherein the target support is loaded with a solid target material that comprises an element that, upon bombardment via a cyclotron, yields at least a radioisotope, wherein the isolation window assembly comprises:
(a) an isolation window that is sized, configured, and comprises materials suitable for the transmission of particles from a cyclotron with enough kinetic energy to transform the element to the radioisotope but not so much as to cause the target support to fail, and suitable to withstand the pressure difference between a vacuum pressure within the target apparatus and atmospheric pressure outside the target apparatus, wherein the isolation window comprises a front surface and back surface, and wherein the isolation window comprises:
(i) a heat conducting layer that comprises a heat conducting material with a thermal conductivity, in-plane, of at least 1,000 W/m-K; and
(ii) optionally, a tensile strength layer in contact with, or secured to the heat conducting layer, wherein the tensile strength layer comprises a high tensile strength material with a tensile strength, ultimate, of at least 800 MPa; and
(b) a collar sized and configured to:
(i) sealingly connect with the isolation window around the perimeter of the isolation window, including portions of the front and back surfaces of isolation window proximate to the perimeter of the isolation window; and
(ii) be sealingly assembled as part of the target apparatus, including forming a seal with, and partially defining an isolation window liquid cooling passageway in the target apparatus thereby allowing liquid to flow through the isolation window liquid cooling passageway and contact at least a portion of the collar and transport heat from the collar.

2. The isolation window assembly of claim 1, wherein:
the heat conducting material is pyrolytic graphite;
the high tensile strength material is selected from the group consisting of molybdenum, molybdenum TZM alloy (Mo-0.5Ti-0.1Zr; Mo alloy 364), cobalt-based alloy UNS R30004, and combinations thereof;
the collar is aluminum or an aluminum alloy.

3. The isolation window assembly of claim 1, wherein:
the heat conducting material is pyrolytic graphite and the heat conducting layer is cylindrical and has an axial thickness in a range of about 10 μm to about 50 μm; and
the high tensile strength material is molybdenum TZM alloy and the tensile strength layer is cylindrical and has an axial thickness in a range of about 20 μm to about 50 μm.

4. A target support for a solid-target-type cyclotron target apparatus, wherein the target support is sized and configured to be sealingly assembled as part of the target apparatus that also comprises a support liquid cooling passageway for flowing a liquid to contact at least a portion of the target support, and wherein the target support comprises:
(a) a front surface having a depression that is sized and configured to load a solid target material that comprises an element that, upon bombardment via a cyclotron, yields at least a radioisotope; and
(b) a back surface sized and configured to seal with, and thereby partially define the support liquid cooling passageway in the target apparatus thereby allowing for liquid to flow through the support liquid cooling passageway and contact at least a portion of the back surface and transport heat from the support.

5. The target support of claim 4, wherein the depression is sized and configured to optimize the amount of target material relative to the size and configuration of the target support and the intended cyclotron particle bombardment.

6. The target support of claim 4, wherein the target support comprises a target support material that is 24 carat gold.

7. The target support of claim 6, wherein the target support is cylindrical having an axial thickness of about 2 mm, a diameter of about 24 mm, and the depression is a coaxial cylindrical void having a depth, measured from the front surface toward the back surface, of about 1.5 mm and a diameter of about 10 mm.

8. The target support of claim 4, wherein the target material comprises an element that, upon bombardment via a cyclotron, yields at least a radioisotope corresponding to at least one of the following element/isotope pairs: ²²⁶Ra/²²⁵Ac.

9. A kit for forming an assembled solid-target-type cyclotron target apparatus, the kit comprising:
(a) an isolation window assembly for solid-target-type cyclotron target apparatus, the isolation window assembly sized and configured to be sealingly assembled as part of the target apparatus that also comprises a target support and a support liquid cooling passageway for flowing a liquid to contact at least a portion of the target support, wherein the target support is loaded with a solid target material that comprises an element that, upon bombardment via a cyclotron, yields at least a radioisotope, wherein the isolation window assembly comprises:
(i) an isolation window that is sized, configured, and comprises materials suitable for the transmission of particles from a cyclotron with enough kinetic energy to transform the element to the radioisotope but not so much as to cause the target support to fail, and suitable to withstand the pressure difference between a vacuum pressure within the target apparatus and atmospheric pressure outside the target apparatus, wherein the isolation window comprises a front surface and back surface, and wherein the isolation window comprises:
a. a heat conducting layer that comprises a heat conducting material with a thermal conductivity, in-plane, of at least 1,000 W/m-K
b. optionally, a tensile strength layer in contact with, or secured to the heat conducting layer, wherein the tensile strength layer comprises a high tensile strength material with a tensile strength, ultimate, of at least 800 MPa; and
(ii) a collar sized and configured to:
a. sealingly connect with the isolation window around the perimeter of the isolation window, including portions of the front and back surfaces of isolation window proximate to the perimeter of the isolation window; and
b. be sealingly assembled as part of the target apparatus, including forming a seal with, and partially defining an isolation window liquid cooling passageway in the target apparatus thereby allowing liquid to flow through the isolation window liquid cooling passageway and contact at least a portion of the collar and transport heat from the collar;
(b) a target support for a solid-target-type cyclotron target apparatus, wherein the target support is sized and configured to be sealingly assembled as part of the target apparatus that also comprises a support liquid cooling passageway for flowing a liquid to contact at least a portion of the target support, and wherein the target support comprises:
(i) a front surface having a depression that is sized and configured to load a solid target material that comprises an element that, upon bombardment via a cyclotron, yields at least a radioisotope; and
(ii) a back surface sized and configured to seal with, and thereby partially define the support liquid cooling passageway in the target apparatus thereby allowing for liquid to flow through the support liquid cooling passageway and contact at least a portion of the back surface and transport heat from the support; and
(c) the remaining components necessary for forming the assembled target apparatus.

10. The kit of claim 9, wherein:
the heat conducting material is pyrolytic graphite;
the high tensile strength material is selected from the group consisting of molybdenum, molybdenum TZM alloy (Mo-0.5Ti-0.1Zr; Mo alloy 364), cobalt-based alloy UNS R30004, and combinations thereof;
the collar is aluminum or an aluminum alloy;
the depression is sized and configured to optimize the amount of target material relative to the size and configuration of the target support and the intended cyclotron particle bombardment;
the target support comprises a target support material that is 24 carat gold; and
the target material comprises an element that, upon bombardment via a cyclotron, yields at least a radioisotope corresponding to at least one of the following element/isotope pairs: ²²⁶Ra/²²⁵Ac.

11. The kit of claim 10, wherein:
the heat conducting layer is cylindrical and has an axial thickness in a range of about 10 μm to about 50 μm; and
the high tensile strength material is molybdenum TZM alloy and the tensile strength layer is cylindrical and has an axial thickness in a range of about 20 μm to about 50 μm; and
the target support is cylindrical having an axial thickness of about 2 mm, a diameter of about 24 mm, and the depression is a coaxial cylindrical void having a depth, measured from the front surface toward the back surface, of about 1.5 mm and a diameter of about 10 mm.

12. A method of producing a radioisotope from a solid target material, the method comprising:
(a) loading a depression of a target support for a solid-target-type cyclotron target apparatus with the solid target material that comprises an element that, upon bombardment via a cyclotron, yields at least a radioisotope, wherein the target support is sized and configured to be sealingly assembled as part of the solid-target-type cyclotron target apparatus that also comprises a support liquid cooling passageway for flowing a liquid to contact at least a portion of the target support, and wherein the target support comprises:
(i) a front surface having a depression that is sized and configured to load a solid target material that comprises an element that, upon bombardment via a cyclotron, yields at least a radioisotope; and
(ii) a back surface sized and configured to seal with, and thereby partially define the support liquid cooling passageway in the target apparatus thereby allowing for liquid to flow through the support liquid cooling passageway and contact at least a portion of the back surface and transport heat from the support;
(b) assembling the solid-target-type cyclotron target apparatus comprising:
(i) the loaded target support;
(ii) an isolation window assembly sized and configured to be sealingly assembled as part of the solid-target-type cyclotron target apparatus, wherein the isolation window assembly comprises:
a. an isolation window that is sized, configured, and comprises materials suitable for the transmission of particles from a cyclotron with enough kinetic energy to transform the element to the radioisotope but not so much as to cause the target support to fail, and suitable to withstand the pressure difference between a vacuum pressure within the target apparatus and atmospheric pressure outside the target apparatus, wherein the isolation window comprises a front surface and back surface, and wherein the isolation window comprises:
i. a heat conducting layer that comprises a heat conducting material with a thermal conductivity, in-plane, of at least 1,000 W/m-K;
ii. optionally, a tensile strength layer in contact with, or secured to the heat conducting layer, wherein the tensile strength layer comprises a high tensile strength material with a tensile strength, ultimate, of at least 800 MPa; and
b. a collar sized and configured to:
i. sealingly connect with the isolation window around the perimeter of the isolation window, including portions of the front and back surfaces of isolation window proximate to the perimeter of the isolation window; and
ii. be sealingly assembled as part of the target apparatus, including forming a seal with, and partially defining an isolation window liquid cooling passageway in the target apparatus thereby allowing liquid to flow through the isolation window liquid cooling passageway and contact at least a portion of the collar and transport heat from the collar; and
(iii) the remaining components necessary for forming the assembled target apparatus; and
(c) directing particles from a cyclotron through the isolation window into the interior of the assembled target apparatus to strike the target material and transform the element to the radioisotope.

13. The method of claim 12 further comprising processing the bombarded target material to isolate the radioisotope.

14. The method of claim 12, wherein:
the heat conducting material is pyrolytic graphite;
the high tensile strength material is selected from the group consisting of molybdenum, molybdenum TZM alloy (Mo-0.5Ti-0.1Zr; Mo alloy 364), cobalt-based alloy UNS R30004, and combinations thereof;
the collar is aluminum or an aluminum alloy;
the depression is sized and configured to optimize the amount of target material relative to the size and configuration of the target support and the intended cyclotron particle bombardment;
the target support comprises a target support material that is 24 carat gold; and
the target material comprises an element that, upon bombardment via a cyclotron, yields at least a radioisotope corresponding to at least one of the following element/isotope pairs: ²²⁶Ra/²²⁵Ac.

15. The method of claim 14, wherein:
the heat conducting layer is cylindrical and has an axial thickness in a range of about 10 μm to about 50 μm; and
the high tensile strength material is molybdenum TZM alloy and the tensile strength layer is cylindrical and has an axial thickness in a range of about 20 μm to about 50 μm; and
the target support is cylindrical having an axial thickness of about 2 mm, a diameter of about 24 mm, and the depression is a coaxial cylindrical void having a depth, measured from the front surface toward the back surface, of about 1.5 mm and a diameter of about 10 mm.
